(19) United States
(12) Patent Application Publication
(10) Pub. No.: US 2008/0267266 A1
(43) Pub. Date: Oct. 30, 2008

(54) Pre-Equalization Apparatus and Method for Reducing Time Delay in On-Channel Repeater

(75) Inventors: Heung-Mook Kim, Daejon (KR); Sung-Ik Park, Daejon (KR); Jae-Hyun Seo, Daejon (KR); Ho-Min Eum, Daejon (KR); Yong-Tae Lee, Daejon (KR); Seung-Won Kim, Daejon (KR); Soo-In Lee, Daejon (KR)

Correspondence Address: CANTOR COLBURN, LLP, 20 Church Street, 22nd Floor, Hartford, CT, 06103, US

(73) Assignee: Electtonics and Telecommunications Research - Institute, Daejon (KR)

(21) Appl. No.: 12/089,468

(22) PCT Filed: Oct. 4, 2006
(86) PCT No.: PCT/KR06/04001

§ 371 Date: Apr. 7, 2008

(30) Foreign Application Priority Data
Oct. 7, 2005 (KR) 10-2005-0094419
Apr. 17, 2006 (KR) 10-2006-0034598

(51) Int. Cl. H04L 25/20

(52) U.S. Cl. 375/211

(57) ABSTRACT

Provided is a pre-equalization apparatus and method that can reduce time delay of an on-channel repeater. The pre-equalization apparatus reduces time delay in an on-channel repeater by generating modified filter coefficient from a given filter coefficient and a pre-equalization filter coefficient after an up-sampling process and filtering up-sampled signals. The pre-equalization apparatus includes: a baseband signal generating unit for forming a baseband signal by combining an inputted signal, field sync signal, and segment sync signal; a pilot adding unit for adding a pilot signal to the baseband signal; an up-sampling unit for up-sampling the baseband signal having the pilot signal; a pre-equalization filter coefficient generating unit for generating a pre-equalization filter coefficient; a modified filter coefficient generating unit for generating a modified filter coefficient by using the pre-equalization filter coefficient and a given filter coefficient; and a filtering unit for filtering the up-sampled signal by using the modified filter coefficient.

### TECHNICAL FIELD

The present invention relates to an on-channel repeater; and, more particularly, to a pre-equalization apparatus that can reduce time delay caused by a filter used in a pre-equalization process in an on-channel repeater, and a method thereof.

### BACKGROUND ART

Generally, main transmitters and repeaters are disposed to provide a broadcasting service according to natural features, geographical objects, and broadcasting coverage of a broadcasting station. The repeaters are set up in areas where broadcasting signals from a main transmitter are received weakly to resolve the problem of weak signal reception in the areas and broaden the coverage of the main transmitter.

FIG. 1 is a diagram showing a broadcasting service using conventional repeaters, each of which uses a different frequency from main transmitter frequency.

In the broadcasting service using the conventional repeaters shown in FIG. 1, a main transmitter 101 transmits signals in a transmission frequency A, and the repeaters 102 to 105 transmits the signals in transmission frequencies B, C, D and E, respectively, which are different from the transmission frequency A. However, the conventional repeaters resolve the problem of weak signal reception from the main transmitter 101 and broaden the broadcasting coverage by using a different frequency. Since the repeaters use a plurality of frequency bands, the conventional broadcasting system requires much frequency resources and this is quite inefficient in the respect of using frequency.

FIG. 2 is a diagram illustrating a service using on-channel repeaters. The on-channel repeaters repeat signals in the same frequency. A main transmitter 201 sends out signals in a transmission frequency A, and on-channel repeaters 202 to 205 repeat the signals in the same frequency A.

The on-channel repeaters shown in FIG. 2 were disclosed by Seong-Ik Park et al. in Korean Patent Publication No. 10-2004-0099878 entitled “On-channel repeater for a terrestrial wave digital TV broadcasting signal and method therefor” published on Dec. 2, 2004.

FIG. 3 is a block view showing an on-channel repeater. The operation of the on-channel repeater will be described with reference to FIG. 3.

The on-channel repeater includes a reception antenna 2, 301, a Radio Frequency (RF) receiver 302, an Intermediate Frequency (IF) down-converter 303, a demodulator 304, an equalizer 305, a modulator 306, an RF up-converter 307, a high-power amplifier 308, a mask filter 309, and a transmission antenna 310.

The RF receiver 302 receives RF signals transmitted from a main transmitter or another repeater through the reception antenna 301. The IF down-converter 303 down-converts the received RF signals into IF signals.

The demodulator 304 demodulates the IF signals obtained from the frequency down-conversion into baseband signals. The equalizer 305 equalizes the baseband signals to compensate for signal distortion caused in a transmission channel and remove feedback signals generated due to low isolation of the transmission and reception antennas of the on-channel repeater.

The modulator 306 modulates channel distortion-compensated baseband signals into IF signals. The RF up-converter 307 up-converts the IF signals into RF signals. The high-power amplifier 308 amplifies the RF signals obtained from the frequency up-conversion. The mask filter 309 eliminates out of channel emission and spurious signals and transmits the filtered RF signals through the transmission antenna 310.

To provide a broadcasting service using the on-channel repeaters using the same transmission frequency as that of the main transmitter in FIG. 3, a receiver should be able to identify whether a signal is transmitted from the main transmitter or another on-channel repeater. Generally, receivers include an equalizer to remove multi-path signals. The equalizer can remove signals temporally delayed and inputted in the same frequency band, other than desired signals.

However, when signals transmitted from the main transmitter and on-channel repeaters have a temporal delay that goes out of the multi-path signal removal ability of the equalizer of the receiver, the equalizer cannot remove the delayed signals.

Therefore, the broadcasting system of FIG. 3 can be realized based on an assumption that the temporal difference between an output signal of the on-channel repeaters received in the receiver and an output signal of the main transmitter received in the receiver should be small. In short, the time delay of the on-channel repeaters should be shortened as much as possible.

Also, the on-channel repeater shown in FIG. 3 includes a mask filter 309 in a transmitting part. The mask filter 309 causes much linear distortion in consideration of preventing out-of-band radiation. The linear distortion degrades the quality of transmission signals and brings about reduced broadcasting coverage of the on-channel repeater.

Therefore, the on-channel repeater should improve the quality of broadcasting signals by using a pre-equalization method and compensating for the linear distortion caused in the RF up-converter, the high-power amplifier, and the mask filter, which are constituent elements following the modulator 306. Generally, the pre-equalization is realized to be included in the modulator 306 of the on-channel repeater shown in FIG. 3.

The modulator 306 of the on-channel repeater is disclosed by Seong-Ik Park et al. in Korean Patent Publication No. 10-2005-0040636 entitled “Modulating apparatus for reducing time delay of on-channel repeater in terrestrial digital TV broadcasting system, particularly regarding to expanding relay area and increasing use efficiency of limited frequency resources” published on May 3, 2005.

FIG. 4 is a block view describing the modulator 306 of the on-channel repeater. The modulator 306 includes a baseband signal generating unit 401, a pilot adding unit 402, a pre-equalization filter coefficient generating unit 403, a pre-equalization filtering unit 404, an up-sampling unit 405, a filtering unit 406, an IF up-converting unit 407, an I-Q adding unit 408, and a digital-to-analog (DA) converting unit (DAC) 409. The baseband signal generating unit 401 forms baseband signals by combining fields and segment sync signals. The pilot adding unit 402 adds a pilot signal to a baseband signal generated in the baseband signal generating unit 401. The pre-equalization filtering unit 404 filters the baseband signal including pilot signal with a pre-equalization filter generated in the pre-equalization filter coefficient generating unit 403 to thereby produce a pre--equalization-filtered baseband signal. The up-sampling unit 405 up-samples the pre-equalization-filtered baseband signal. The filtering unit 406 filters the up-sampled baseband signal into an In-phase (I) signal and a Quadrature (Q) signal through a pulse shaping filter. The IF up-converting unit 407 up-converts the filtered I and Q baseband signals into IF I and Q signals. The I-Q adding unit 408 summates the IF I and Q signals obtained from the IF up-conversion and thereby produces an IF signal. The DA converting unit 409 converts the digital IF signal into an analog IF signal.

When the modulator 306 adopting the conventional pre-equalization shown in FIG. 4 is used in the on-channel repeater, much time delay is caused by the pre-equalization filter itself. This makes the time delay in the on-channel repeater long and eventually deteriorates equalization ability of the commercial receiver.

Time delay caused by the pre-equalization filtering unit 404 and the filtering unit 406 can be calculated as follows.

The pre-equalization filter generated in the pre-equalization filter coefficient generating unit 403 is operated based on a symbol rate, and the total number of taps included in the pre-equalization filter is C1+D1+1. A main tap is disposed at a position of C1+1 in the front. Thus, the time delay caused by the pre-equalization filtering unit 404 is C1 symbol time.

The filtering unit 406 includes an I filter and a Q filter. The number of taps in each of the I filter and the Q filter is C2+D2+1. A main tap is disposed at a position of C2+1 in the front. When the up-sampling rate of the up-sampling unit 405 is K, the time delay caused by the filtering unit 406 operated at the up-sampling rate K is C2/K symbol time.

Therefore, the modulator 306 adopting the conventional pre-equalization method comes to have time delay of C1+C2/K symbol time. In other words, the adoption of the pre-equalization method increases time delay of the on-channel repeater by C1 symbol time.

In consequences, it is required to develop a pre-equalization apparatus and method that has a small time difference between the output signals of the on-channel repeater received in the receiver and the output signals of the main transmitter received in the receiver, that is, a pre-equalization apparatus and method that can reduce time delay in the on-channel repeater.

### DISCLOSURE

### Technical Problem

It is, therefore, an object of the present invention to provide a pre-equalization apparatus that can reduce time delay in an on-channel repeater by generating a modified filter coefficient from a given filter coefficient and a pre-equalization filter coefficient after an up-sampling process and filtering up-sampled signals, and a method thereof.

Other objects and advantages of the present invention can be understood by the following description and become apparent by the embodiments of the present invention. Also, it is obvious to those skilled in the art of the present invention that the objects and advantages of the present invention can be realized by the means as claimed and combinations thereof.

### Technical Solution

In accordance with one aspect of the present invention, there is provided a pre-equalization apparatus for an on-channel repeater repeating signals in a same frequency, which includes: a baseband signal generating unit for forming a baseband signal by combining an inputted signal, field sync signal and segment sync signal; a pilot adding unit for adding a pilot signal to the baseband signal; an up-sampling unit for up-sampling the baseband signal having the pilot signal added thereto; a pre-equalization filter coefficient generating unit for generating a pre-equalization filter coefficient; a modified filter coefficient generating unit for generating a modified filter coefficient by using the pre-equalization filter coefficient and a given filter coefficient; and a filtering unit for filtering the up-sampled signal by using the modified filter coefficient.

In accordance with another aspect of the present invention, there is provided a pre-equalization method for an on-channel repeater repeating signals in a same frequency, which includes the steps of: a) forming a baseband signal by combining an inputted signal, field sync signal and segment sync signal; b) adding a pilot signal to the generated baseband signal; c) up-sampling the baseband signal having the pilot signal added thereto; d) generating a pre-equalization filter coefficient; e) generating a modified filter coefficient by using the pre-equalization filter coefficient and a given filter coefficient; and f) filtering the up-sampled signal by using the modified filter coefficient.

### Advantageous Effects

The present invention can minimize time delay in an on-channel repeater and increase an efficiency of using frequency resources, whose quantity is limited, with an improved on-channel repeating performance.

### DESCRIPTION OF DRAWINGS

The above and other objects and features of the present invention will become apparent from the following description of the preferred embodiments given in conjunction with the accompanying drawings, in which:

FIG. 1 is a view showing a broadcasting service using conventional repeaters;

FIG. 2 is a view illustrating a broadcasting service using conventional on-channel repeaters;

FIG. 3 is a block view describing a structure of an on-channel repeater;

FIG. 4 is a block view showing a modulator of the on-channel repeater;

FIG. 5 is a block view describing a pre-equalization apparatus for an on-channel repeater in accordance with an embodiment of the present invention;

FIG. 6 shows a modified filter coefficient generation process in a modified filter coefficient generating unit; and

FIG. 7 is a flowchart describing a pre-equalization method of the on-channel repeater in accordance with an embodiment of the present invention.

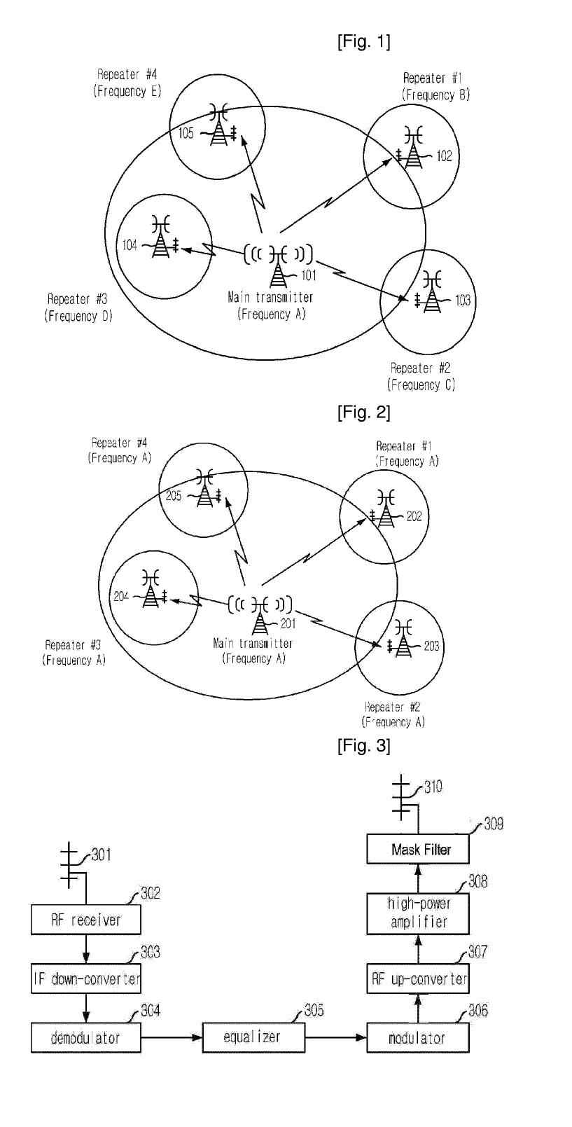

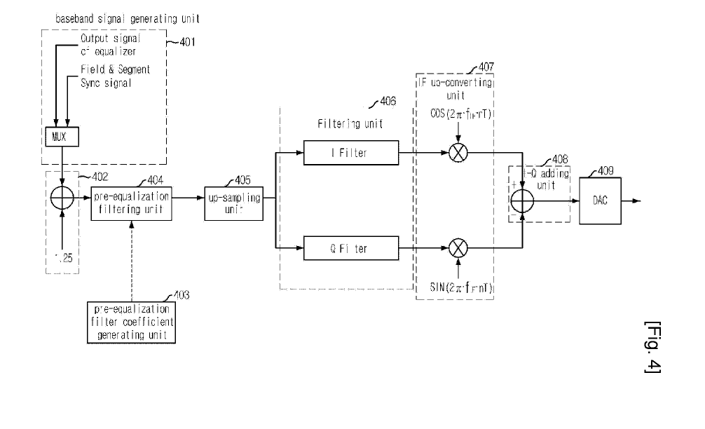

### MODE FOR INVENTION

Other objects and aspects of the invention will become apparent from the following description of the embodiments with reference to the accompanying drawings, which is set forth hereinafter. When it is considered detailed description on a prior art may obscure the points of the present invention, the description will not be provided herein. Hereinafter, embodiments of the present invention will be described in detail with reference to the accompanying drawings.

A pre-equalization apparatus and method of an on-channel repeater suggested in the present invention is appropriate for digital television broadcasting based on the Advanced Television Systems Committee (ATSC) Protocols and Digital Video Broadcasting (DVB). However, the present invention is not limited to them, and it can be applied to any environment where repeaters are needed to form a general single frequency network.

FIG. 5 is a block view describing a pre-equalization apparatus for an on-channel repeater in accordance with an embodiment of the present invention.

The pre-equalization apparatus for an on-channel repeater suggested in the present invention includes a baseband signal generating unit 501, a pilot adding unit 502, an up-sampling unit 503, a pre-equalization filer coefficient generating unit 504, a modified filter coefficient generating unit 505, a filtering unit 506, an intermediate frequency (IF) up-converting unit 507, an I-Q adding unit 508, and a digital-to-analog converting unit (DAC) 509.

The baseband signal generating unit 501 forms a baseband signal by combining an output signal of the equalizer used in the on-channel repeater, a field sync signal, and a segment sync signal, and the pilot adding unit 502 adds a pilot signal to the baseband signal formed in the baseband signal generating unit 501.

Meanwhile, the up-sampling unit 503 performs up-sampling onto the baseband signal having the pilot signal added thereto, and the filtering unit 506 converts the up-sampled baseband signal into an In-phase (I) signal and a Quadrature (Q) signal and performs filtering onto the I and Q signals. Herein, the filtering unit 506 may perform the filtering by using an Equi-Ripple (ER) filter and a window technique, or it may perform the filtering by using a Square Root Raised Cosine (SRRC) filter and the window technique, or it may perform the filtering by using only the ER filter.

The pre-equalization filter coefficient generating unit 504 generates a pre-equalization filter coefficient based on a reference signal, which may be varied by a system operator. The modified filter coefficient generating unit 505 performs convolution onto the pre-equalization filter coefficient and an existing filter coefficient of the filtering unit 506 to thereby produce a new filter coefficient and transmits the newly generated filter coefficient to the filtering unit 506. Filtering in the filtering unit 506 is performed based on the new filter coefficient.

Subsequently, the IF up-converting unit 507 up-converts the filtered I and Q signals into IF I and Q signals, and the I-Q adding unit 508 summates the IF I and Q signals into an IF signal. The DA converting unit 509 converts the IF signal into an analog signal.

A pre-equalization process will be described more in detail, hereinafter.

The filter coefficient of the filtering unit 506 is provided by the pre-equalization filter coefficient generating unit 504 and the modified filter coefficient generating unit 505. The pre-equalization filter coefficient generating unit 504 generates a pre-equalization filter coefficient, in which the total number of taps is N1+M1+1 and a main tap is disposed at a position of N1+1, based on a predetermined pre-equalization algorithm operating at an up-sampling rate L, and transmits the pre-equalization coefficient to the modified filter coefficient generating unit 505.

The modified filter coefficient generating unit 505 performs convolution onto the pre-equalization filter coefficient transmitted from the pre-equalization filter coefficient generating unit 504 and a given filter coefficient of the filtering unit 506. In the given filter coefficient of the filtering unit 506, the number of the entire taps is N2+M2+1 and a main tap is disposed at a position of N2+1. A new filter coefficient obtained from the convolution has N1+N2+M1+M2+1 taps in total and a main tap disposed at a position of N1+N2+1.

The modified filter coefficient generating unit 505 may remove some taps of the filter coefficient obtained from the convolution, if it is necessary to remove the filter coefficient to reduce time delay. In other words, the modified filter coefficient generating unit 505 adjusts the number of pre-taps N3 (N3≦N1+N2) among the total number of the taps, which is N1+N2+M1+M2+1, and, if necessary, it may also adjust the number of post-taps M3 (M3≦M1+M2) to make the total number of taps to be N3+M3+1 and make the main tap disposed at a positioned of N3+1 so that the filtering unit 506 can perform filtering with a short time delay.

FIG. 6 shows a modified filter coefficient generation process in the modified filter coefficient generating unit 505.

Referring to FIG. 6(a), the pre-equalization filter coefficient generating unit 504 generates a pre-equalization filter coefficient in which the total number of taps is N1+-M1+1, and the number of pre-taps is N1 and the number of post-taps is M1 based on a predetermined pre-equalization algorithm operating at an up-sampling rate L.

Referring to FIG. 6(b), the filtering unit 506 has a given filter coefficient in which the total number of taps is N2+M2+1, and the number of pre-taps is N2, while the number of post-taps is M2.

The modified filter coefficient generating unit 505 performs convolution onto the pre-equalization filter coefficient generated in the pre-equalization filter coefficient generating unit 504 and the given filter coefficient of the filtering unit 506.

A filter coefficient obtained from the convolution, which will be simply referred to as a convolution filter coefficient, has N1+N2+M1+M2+1 taps in total, N1+N2 pre-taps, and M1+M2 post-taps.

The modified filter coefficient generating unit 505 may remove the convolution filter coefficient to reduce time delay, if necessary. In short, as shown in FIG. 6(d), the number of the pre-taps is adjusted into N3 (N3≦N1+N2), and the number of the post-taps may be adjusted into M3 (M3≦M1+M2), if necessary.

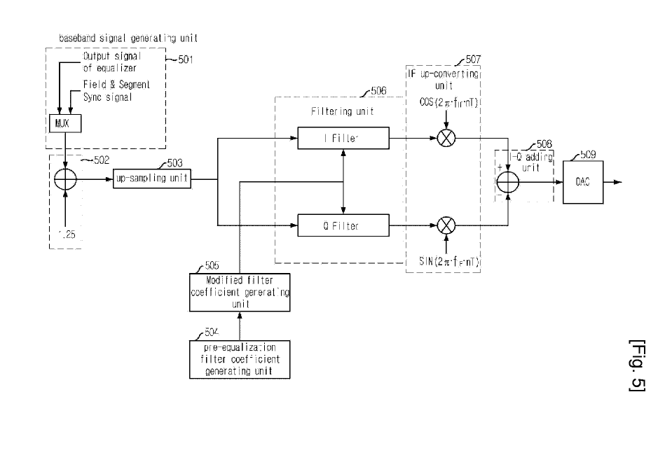

If the filtering unit 506 of FIG. 5 uses the same filter as the conventional filtering unit 406 illustrated in FIG. 4, the number of pre-taps of the conventional filtering unit 406 is the same as the number of pre-taps of the filtering unit 506 (C2=N2) and the number of post-taps of the conventional filtering unit 406 is the same as the number of post-taps of the filtering unit 506 (D2=M2). The up-sampling rates are the same, too (K=L). Herein, the number of pre-taps of the filtering unit 506 becomes N3 (N3≦N1+N2) by the pre-equalization filter coefficient generating unit 504 and modified filter coefficient generating unit 505. Therefore, time delay of the filtering unit 506 is expressed as shown in Equation 1.

N3/L≦(N1+N2)/L=(N1+C2)/K Eq. 1

Furthermore, when the number of pre-taps C1 of the pre-equalization filtering unit 404 of FIG. 4 and the number of pre-taps N1 of the pre-equalization filter coefficient generating unit 504 of FIG. 5 satisfy C1=N1/L, and the number of post-taps D1 of the pre-equalization filtering unit 404 of FIG. 4 and the number of post-taps M1 of the pre-equalization filter coefficient generating unit 504 of FIG. 5 satisfy D1=M1/L, the time delay of the Equation 1 can be induced as shown in Equation 2.

N3/L≦(K×C1+C2)/K=C1+C2/K Eq. 2

Therefore, the filtering unit 506 of FIG. 5 can have the same number of filter coefficient as the filtering unit 406 of FIG. 4, which has a time delay of C1+C2/K, but reduced time delay as shown in Equation 2.

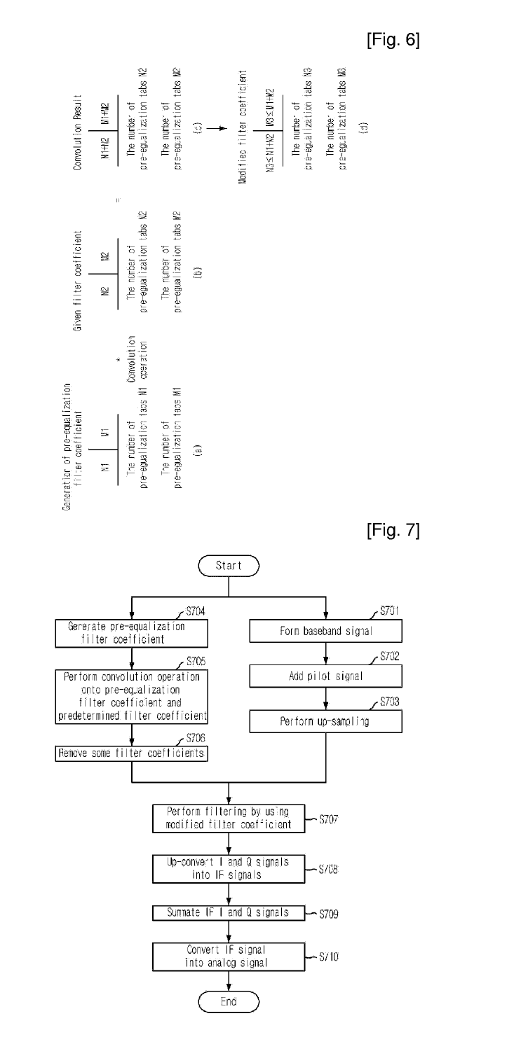

FIG. 7 is a flowchart describing a pre-equalization method of the on-channel repeater in accordance with an embodiment of the present invention. As shown in the drawing, at step S701, a baseband signal is formed by combining an output signal of an equalizer used in the on-channel repeater, a field sync signal, and segment sync signal.

At step S702, a pilot signal is added to the baseband signal and, at step S703, the baseband signal with the pilot signal added thereto is up-sampled.

Meanwhile, at step S704, a pre-equalization filter coefficient is generated based on a predetermined pre-equalization algorithm operating at the up-sampling rate. At step S705, convolution is performed onto the generated pre-equalization filter coefficient and the predetermined filter coefficient to thereby generate a new filter coefficient, which will be referred to as a convolution filter coefficient.

For example, a pre-equalization filter coefficient in which the total number of taps is N1+M1+1 and a main tap is positioned at N1+1 is generated. The generated pre-equalization filter coefficient is convoluted with a given filter coefficient in which the total number of taps is N2+M2+1 and a main tap is disposed at a position of N2+1. The convolution filter coefficient has N1+N2+M1+M2+1 taps in total and a main tap disposed at a position of N1+N2+1.

Subsequently, at step S706, some of the convolution filter coefficient is removed to reduce time delay. In other words, the number of the pre-taps N3 among the total number of taps, i.e., N1+N2+M1+M2+1, is adjusted to perform filtering with a short time delay. If necessary, the number of post-taps M3 may be adjusted, too (M3<M1+M2).

At step S707, the up-sampled baseband signal is filtered using a modified convolution filter coefficients.

At step S708, the filtered I and Q signals are up-converted into IF signals and, at step S709, the IF I and Q signals are summated into a signal. At step S710, the obtained IF signal is converted into an analog signal.

The method of the present invention which is described above can be realized as a program and stored in a computer-readable recording medium such as CD-ROM, RAM, ROM, a floppy disk, a hard disk, and a magneto-optical disk. Since the process can be easily realized by those skilled in the art to which the present invention pertains, the process will not be described in detail herein.

The present invention can improve the efficiency of frequency resources, whose quantity is limited, with an improved performance of an on-channel repeater as well as minimizing time delay of an on-channel repeater.

The present application contains subject matter related to Korean Patent Application No. 2005-94419 and 2006-34598, filed with the Korean Intellectual Property Office on Oct. 7, 2005, and Apr. 17, 2006, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A pre-equalization apparatus for an on-channel repeater repeating signals in a same frequency, the apparatus comprising:
a baseband signal generating means for forming a baseband signal by combining an inputted signal, field sync signal, and segment sync signal;
a pilot adding means for adding a pilot signal to the baseband signal;
an up-sampling means for up-sampling the baseband signal having the pilot signal added thereto;
a pre-equalization filter coefficient generating means for generating a pre-equalization filter coefficient;
a modified filter coefficient generating means for generating a modified filter coefficient by using the pre-equalization filter coefficient and a given filter coefficient; and
a filtering means for filtering the up-sampled signal by using the modified filter coefficient.

2. The apparatus as recited in claim 1, wherein the modified filter coefficient generating means performs convolution onto the pre-equalization filer coefficient and the given filter coefficient to thereby produce a new filter coefficient, which will be referred to as a convolution filter coefficient.

3. The apparatus as recited in claim 2, wherein the modified filter coefficient generating means reduces the number of taps of the convolution filter coefficient.

4. The apparatus as recited in claim 3, wherein the modified filter coefficient generating means reduces the number of pre-taps among the entire taps of the convolution filter coefficient.

5. A pre-equalization method for an on-channel repeater repeating signals in a same frequency, comprising the steps of:
a) forming a baseband signal by combining an inputted signal, field sync signal, and segment sync signal;
b) adding a pilot signal to the generated baseband signal;
c) up-sampling the baseband signal having the pilot signal added thereto;
d) generating a pre-equalization filter coefficient;
e) generating a modified filter coefficient by using the pre-equalization filter coefficient and a given filter coefficient; and
f) filtering the up-sampled signal by using the modified filter coefficient.

6. The pre-equalization method as recited in claim 5, wherein the generated pre-equalization filter coefficient is convoluted with a given filter coefficient in the modified filter coefficient generation step e) to thereby produce a new filter coefficient, which will be referred to as a convolution filter coefficient.

7. The pre-equalization method as recited in claim 6, wherein the number of taps of the convolution filter coefficient is reduced in the modified filter coefficient generation step e).

8. The pre-equalization method as recited in claim 7, wherein the number of pre-taps among the entire taps of the convolution filter coefficient is reduced in the modified filter coefficient generation step e).
